(19) United States
(12) Patent Application Publication
(10) Pub. No.: US 2011/0060977 A1
(43) Pub. Date: Mar. 10, 2011

(54) METHOD AND SYSTEM FOR EMBEDDING AND SHARING INFORMATION

(75) Inventors: Deepshikha JINDAL, Noida (U.P) (IN); Shubham Baidyanath BHATTACHARYA, Bangalore (IN); Raghu Tumkur NAGARAJA, Bangalore (IN); Bhanu Prakash BOMMA, Bangalore (IN)

(73) Assignee: SAMSUNG ELECTRONICS CO., LTD., Gyeonggi-Do (KR)

(21) Appl. No.: 12/878,133

(22) Filed: Sep. 9, 2010

(30) Foreign Application Priority Data
Sep. 9, 2009 (IN) 2183/CHE/2009

(51) Int. Cl. G06F 3/14

(52) U.S. Cl. 715/201

(57) ABSTRACT

A method for embedding information in a file includes generating a thumbnail of the multimedia file. The method also includes embedding information associated with the thumbnail, wherein the embedding includes identifying one or more markers to fill in the information on a visual media sheet and associating the thumbnail with the information. The method further includes arranging the generated thumbnails based on spatial details and saving the arranged thumbnails with the associated information in the file. The method can be implemented on an electronic device that includes a visual media sheet generator for generating the visual media sheet based on one or more markers, and a thumbnail organization unit for arranging the thumbnails in a pre-defined pattern.

### CLAIM OF PRIORITY

This application claims priority under 35 U.S.C. §119(a) to an application filed in the Indian Patent Office on Sep. 9, 2009 and assigned Serial No. 2183/CHE/2009, the content of which is incorporated herein by reference.

### BACKGROUND OF THE INVENTION

1. Field of the Invention

The present disclosure relates generally to the field of communication devices and more particularly to the field of embedding and sharing information in a file between one or more communication devices.

2. Description of the Related Art

Often, a multimedia file is shared amongst communication devices. The multimedia file includes limited content of the multimedia file and its metadata. One technique for sharing contact information includes providing the contact information one at a time to the recipient communication device. This technique uses more bandwidth and consumes more time. The technique may not share information which has multiple entries.

In another existing technique, an image is converted to a thumbnail and linked to one contact information. While sharing the contact information, the technique may not provide the image because the image is not embedded with the contact information

In most scenarios, the memory allotted for storing the contact information is limited in a communication device. The communication device may not be able to store new contacts when the allotted memory is filled.

The existing methods of sharing may not share an event detail to a set of communication devices. The method may not allow the communication device to transmit an event time and date, an agenda of the event or a venue of the event. In light of the foregoing discussion there is a need for a method and a system for embedding and sharing information in a file.

### SUMMARY OF THE INVENTION

Embodiments of the present disclosure described herein provide a method and system for embedding and sharing information in a file.

In one embodiment, a method for embedding information in a file that is operable in a processor includes generating a thumbnail of a multimedia file. The method also includes embedding information associated with the thumbnail. The embedding information includes identifying one or more markers to fill in the information on a visual media sheet and associating the thumbnail with the information. The method further includes arranging generated thumbnails based on spatial details and saving the arranged thumbnails with the associated information in a file.

In another embodiment, the invention includes an electronic device for sharing embedded information in a multimedia file. The electronic device includes a thumbnail generation unit for generating one or more thumbnails, and a visual media sheet generator for generating the visual media sheet based on one or more markers. The electronic device further includes a storage unit for storing the generated visual media sheet, a thumbnail organization unit for arranging the thumbnails in a predefined pattern and a display for displaying the file.

In yet another embodiment, the invention includes processor-readable medium including a set of processor readable instructions that when executed by a processor in an electronic device cause a method for sharing embedded information in a multimedia file. The method includes generating a thumbnail of a multimedia file, embedding information associated with the thumbnail by identifying one or more markers to fill in the information on a visual media sheet and associating the thumbnail with the information, arranging the generated thumbnails based on spatial details and saving the arranged thumbnails with the associated information in file to be shared.

### BRIEF DESCRIPTION OF THE DRAWINGS

The accompanying figures, similar reference numerals may refer to identical or functionally similar elements. These reference numerals are used in the detailed description to illustrate various embodiments and to explain various aspects and advantages of the present disclosure.

FIG. 1 is a block diagram of an environment, in accordance with which various embodiments of the invention can be implemented;

FIG. 2 is a block diagram of an electronic device for embedding and sharing information in a file, in accordance with one embodiment;

FIG. 3 is a block diagram of an electronic device for receiving information in a file, in accordance with one embodiment;

FIG. 4 is a flowchart illustrating a method for embedding and sharing information in a file, in accordance with one embodiment;

FIG. 5 exemplary illustrates creation of a file, in accordance with one embodiment; and

FIG. 6 illustrates an exemplary file with embedded information, in accordance with one embodiment.

Persons skilled in the art will appreciate that elements in the figures are illustrated for simplicity and clarity and may have not been drawn to scale. For example, the dimensions of some of the elements in the figures may be exaggerated relative to other elements to help to improve understanding of various embodiments of the present disclosure.

### DETAILED DESCRIPTION OF THE INVENTION

It should be observed that method steps and system components have been represented by conventional symbols in the figures, showing only specific details that are relevant for an understanding of the present disclosure. Further, details that may be readily apparent to person ordinarily skilled in the art may not have been disclosed. In the present disclosure, relational terms such as first and second, and the like, may be used to distinguish one entity from another entity, without necessarily implying any actual relationship or order between such entities. Embodiments of the present disclosure described herein provide a method and system for embedding and sharing information in a file.

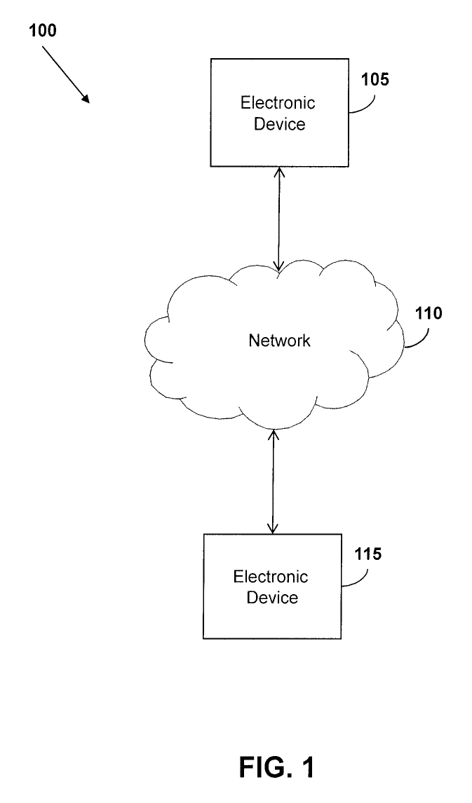

FIG. 1 is a block diagram of an environment 100, in accordance with which various embodiments can be implemented. The environment 100 includes an electronic device 105. An example of the electronic device includes but is not limited to a mobile phone, a computer, a laptop, a printer, a headset and a personal digital assistant (PDA). The electronic device 105 is connected to another electronic device 115 over a network 110. The network 110 may be configured with one of wired or wireless communication means. Examples of the wireless communication means include but are not limited to Wireless Fidelity (WiFi), an infrared channel, a radio frequency channel and Bluetooth. Examples of the wired communication means include but are not limited to a video graphics array (VGA) cable, and a universal serial bus (USB) connection.

The electronic device 105 is used for creating a file. The creating of the file includes generating a plurality of thumbnails for a plurality of multimedia files. Examples of the multimedia files include but are not limited to an image file, a text file, an audio file, a video file and a combination thereof.

The plurality of thumbnails is arranged in a file, based on one or more spatial details. The spatial details include but are not limited to height of the thumbnail, width of the thumbnail, and co-ordinate values of the thumbnail. The arranged thumbnails are saved along with the associated information as the file. The examples of the information can be a contact file, a web link file, a text file, a multimedia file and a meeting request file.

In one embodiment, the file is rendered to the user on a user interface of the electronic device 105. In another embodiment, the file is shared with the plurality of devices, for example, the electronic device 115, over a network 110. The user of the electronic device 115 can receive the information associated with the plurality of thumbnails in a single file.

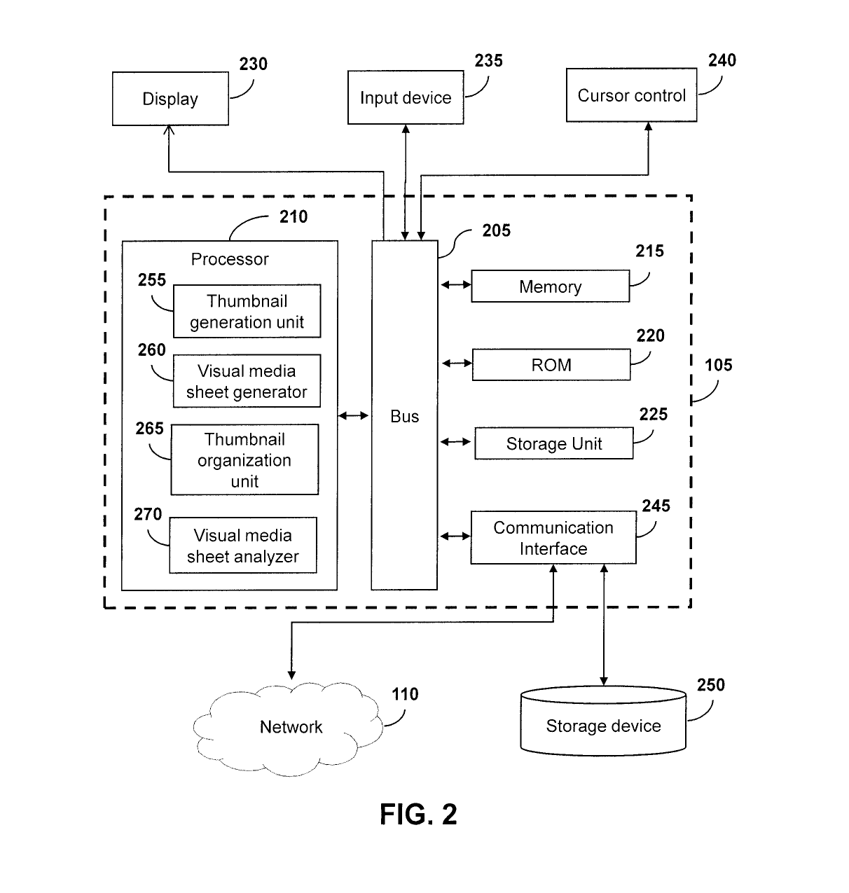

FIG. 2 is a block diagram of an electronic device 105 for embedding and sharing information in a file, in accordance with one embodiment.

The electronic device 105 includes a bus 205 or other communication mechanism for communicating information. The electronic device 105 includes a processor 210 coupled with the bus 205. The processor 210 can include an integrated electronic circuit for processing and controlling functionalities of the electronic device 105. The electronic device 105 also includes a memory 215, such as a random access memory (RAM) or other dynamic storage device, coupled to the bus 205 for storing information which can be used by the processor 210. The memory 215 can be used for storing any temporary information required. The electronic device 105 further includes a read only memory (ROM) 220 or other static storage device coupled to the bus 205 for storing static information for the processor 210. A storage unit 225, such as a magnetic disk or optical disk, is provided and coupled to the bus 205 for storing information.

The electronic device 105 can be coupled via the bus 205 to a display 230, such as a cathode ray tube (CRT), a liquid crystal display (LCD) or a light emitting diode (LED) display, for displaying information. An input device 235, including alphanumeric and other keys, is coupled to the bus 205 for communicating an input to the processor 210. The input device can be included in the electronic device 105. Another type of user input device is a cursor control 240, such as a mouse, a trackball, or cursor direction keys for communicating the input to the processor 210 and for controlling cursor movement on the display 230. The input device 235 can also be included in the display 230, for example a touch screen. Various embodiments are related to the use of the electronic device 105 for implementing the techniques described herein. In one embodiment, the techniques are performed by the processor 210 using information included in the memory 215. The information can be read into the memory 215 from another processor-readable or machine-readable medium, such as the storage unit 225.

The terms “processor-readable medium” and “machine-readable medium” as used interchangeably herein refer to any medium that participates in providing data that causes a machine or processor to operate in a specific fashion. In an embodiment implemented using the electronic device 105, various machine-readable medium are involved, for example, in providing information to the processor 210. The machine-readable medium can be a storage media. Storage media includes both non-volatile media and volatile media. Non-volatile media includes, for example, optical or magnetic disks, such as the storage unit 225. Volatile media includes dynamic memory, such as the memory 215. All such media must be tangible to enable the information carried by the media to be detected by a physical mechanism that reads the information into a machine. Common forms of machine-readable medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge.

In another embodiment, the processor-readable or machine-readable medium can be a transmission media including coaxial cables, copper wire and fiber optics, including the wires that include the bus 205. Transmission media can also take the form of acoustic or light waves, such as those generated during radio-wave and infra-red data communications. The electronic device 105 also includes a communication interface 245 coupled to the bus 205. The communication interface 245 provides a two-way data communication coupling to the network 110. The network 110 used may be a Bluetooth Pico-net network structure.

In some embodiments, the electronic device 105 can be connected to the storage device 250 for storing or fetching information. Examples of the storage device 250 include, but are not limited to, a flash drive, a pen drive, a hard disk or any other storage media.

In one embodiment, the processor 210 can include or can be connected to one or more processing units, for example a thumbnail generation unit 255, a visual media sheet generator 260 and a thumbnail organization unit 265.

The thumbnail generation unit 255 generates one or more thumbnails corresponding to one or more multimedia files. The visual media generator 260 generates a visual media sheet based on one or more markers. The information associated with the one or more thumbnails is embedded in the visual media sheet. The thumbnail organization unit 265 arranges the thumbnails in a pre-defined pattern, for example the arrangement of the one or more thumbnails is based on spatial details of the one or more thumbnails. The arranged thumbnails and the associated information are saved as a file in the storage unit 225. The arranged one or more thumbnails are rendered on a user interface of the electronic device 110. The display 230 is used to display the file.

In another embodiment, the processor 210 can include or can be connected to a visual media sheet analyzer 270. The visual media sheet analyzer 270 extracts the information from the thumbnails and renders the thumbnails and the corresponding information on the display 230. The examples of the information can be a contact file, a web link file, a text file, a multimedia file and a meeting request file.

In another embodiment, the electronic device 105 may not include the processing units as the functions of the one or more processing units can be performed by the processor 215.

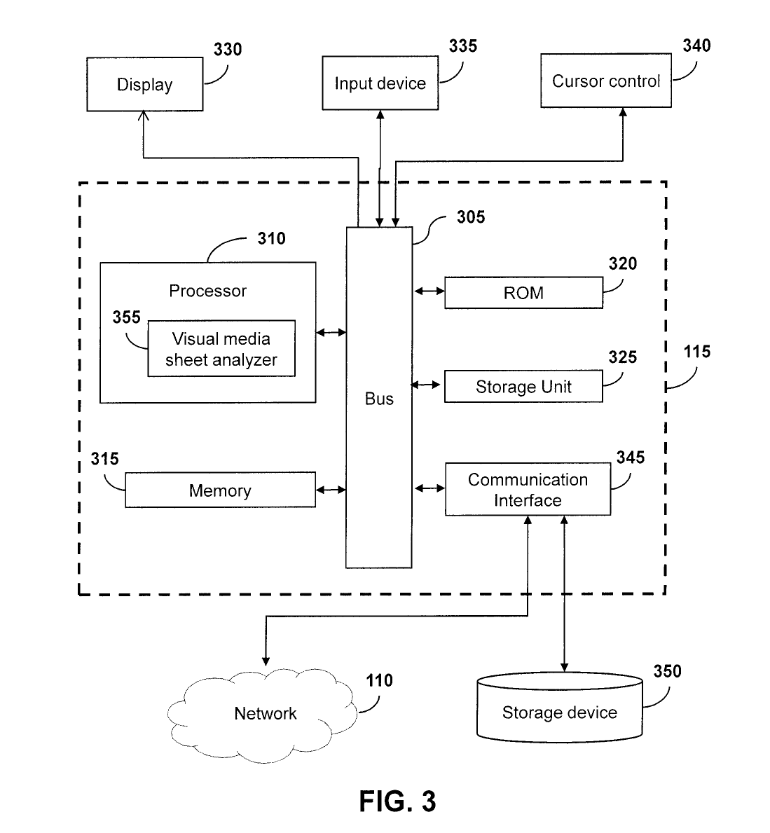

FIG. 3 is a block diagram of an electronic device 115 for receiving information in a file, in accordance with one embodiment.

The electronic device 115 includes a bus 305 or other communication mechanism for communicating information. The electronic device 115 includes a processor 310 coupled with the bus 305. The processor 310 can include an integrated electronic circuit for processing and controlling functionalities of the electronic device 115. The electronic device 115 also includes a memory 315, such as a random access memory (RAM) or other dynamic storage device, coupled to the bus 305 for storing information which can be used by the processor 310. The memory 315 can be used for storing any temporary information required. The electronic device 115 further includes a read only memory (ROM) 320 or other static storage device coupled to the bus 305 for storing static information for the processor 310. A storage unit 325, such as a magnetic disk or optical disk, is provided and coupled to the bus 305 for storing information.

The electronic device 115 can be coupled via the bus 305 to a display 330, such as a cathode ray tube (CRT), a liquid crystal display (LCD) or a light emitting diode (LED) display, for displaying information. An input device 335, including alphanumeric and other keys, is coupled to the bus 305 for communicating an input to the processor 310. The input device can be included in the electronic device 115. Another type of user input device is a cursor control (340), such as a mouse, a trackball, or cursor direction keys for communicating the input to the processor 310 and for controlling cursor movement on the display 330. The input device 335 can also be included in the display 330, for example a touch screen. Various embodiments are related to the use of the electronic device 115 for implementing the techniques described herein. In one embodiment, the techniques are performed by the processor 310 using information included in the memory 315. The information can be read into the memory 315 from another processor-readable medium or machine-readable medium, such as the storage unit 325.

The terms “processor readable medium” and “machine-readable medium” as used interchangeably herein refer to any medium that participates in providing data that causes a machine to operate in a specific fashion. In an embodiment implemented using the electronic device 115, various machine-readable medium are involved, for example, in providing information to the processor 310. The machine-readable medium can be a storage media. Storage media includes both non-volatile media and volatile media. Non-volatile media includes, for example, optical or magnetic disks, such as the storage unit 325. Volatile media includes dynamic memory, such as the memory 315. All such media must be tangible to enable the information carried by the media to be detected by a physical mechanism that reads the information into a machine.

Common forms of machine-readable and processor-readable medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fiber optics, including the wires that include the bus 305. Transmission media can also take the form of acoustic or light waves, such as those generated during radio-wave and infra-red data communications. The electronic device 115 also includes a communication interface 345 coupled to the bus 305. The communication interface 345 provides a two-way data communication coupling to the network 110. The network 110 used may be a Bluetooth Pico-net network structure.

In some embodiments, the electronic device 115 can be connected to the storage device 350 for storing or fetching information. Examples of the storage device 350 includes, but are not limited to, a flash drive, a pen drive, a hard disk or any other storage media.

In one embodiment, the processor 310 can include or be connected to one or more processing units, for example a visual media sheet analyzer 355. The visual media sheet analyzer 355 extracts the information from the file. The examples of the information can be a contact file, a web link file, a text file, a multimedia file and a meeting request file. The information is embedded to the corresponding thumbnail. Based on the embedded information a single file with a visual of all the thumbnails is provided on the display 330 of the electronic device 115. In one embodiment, the information and the thumbnails are provided in parallel on the display 330.

In some embodiments, a thumbnail generation unit, a visual media sheet generator and a thumbnail organization unit can be present in the electronic device 115 for generating and sharing a file.

In another embodiment, the electronic device 115 may not include the processing units as the functions of the processing units can be performed by the processor 310.

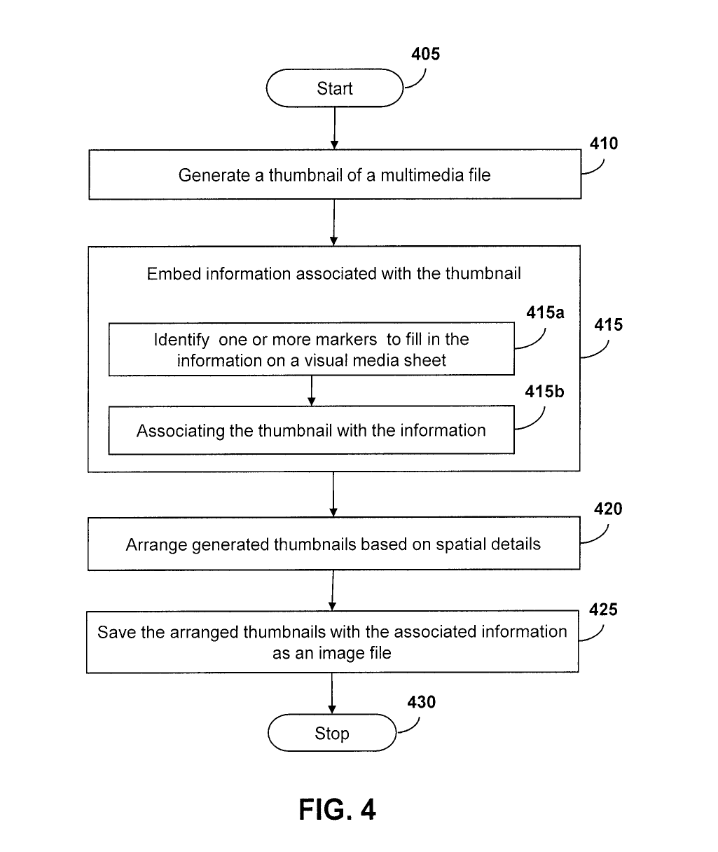

FIG. 4 is a flowchart illustrating a method for embedding and sharing information, in accordance with one embodiment.

The method starts at step 405.

At step 410, a thumbnail of the multimedia file is generated. The multimedia file can be at least one of an image, a text file, an audio file, a video file and a combination thereof. The generated thumbnail is saved in a storage unit. The saved thumbnails may be used at a later point of time by the electronic device to generate the file. In one embodiment, the thumbnails are directly used to create a file without saving the thumbnails.

At step 415, the information associated with the thumbnail is embedded. The embedding of the information is based on the steps 415a and 415b as described below. Examples of the information include but are not limited to a contact file, a web link file, a text file, a multimedia file and a meeting request file. At step 415a, one or more markers are identified to fill in the information on a visual media sheet. The markers refer to a bit stream having a specific and a pre-defined meaning. The functions of the markers include but are not limited to identifying a start of a specific data, identifying an end of a specific data and a combination thereof in a visual media sheet.

In one embodiment, at least one marker is used to identify a start address of the visual media sheet and an end address of the visual media sheet. A marker is used to identify a reference structure. The reference structure includes but is not limited to a title of the visual media sheet, a count of information entries, a length of the information, labeling if the information is compressed, an index count, a size of the entry reference structure, labeling if the information is cryptic. A marker is used to identify the information. The information can be at least one of a contact details, a web link, a text, a multimedia data and a meeting details. An exemplary for mat of the visual media sheet is illustrated in the Table 1 below:

TABLE 1

| | | | | |
|---|---|---|---|---|
| Field | Format | Value | Data in File (Hex) | Size in Bytes |

Visual media sheet (VMS) data starts

| | | | | |
|---|---|---|---|---|
| Identifier (for VCS) | ASCII | TIS0 | 54 59 53 30 | 4 |

Entry reference structure

| | | | | |
|---|---|---|---|---|
| Label for entry | ASCII | ERS0 | 45 52 53 00 | 4 |
| reference structure | | | | |
| Size of ERS | | | XX XX | 2 |
| (Excl ERS label) | | | | |
| CES index count | | | XX XX | 2 |
| Title | ASCII | | XX XX | 40 |

Information Entry [1 . . . n]

| | | | | |
|---|---|---|---|---|
| Label for Information | ASCII | IES0 | 43 45 53 00 | 4 |
| entry structure | | | | |
| Index | | | XX XX | 2 |
| X | | | XX XX | 2 |
| Y | | | XX XX | 2 |
| Width | | | XX XX | 2 |
| Height | | | XX XX | 2 |
| [Type] [Size] [Data] | | | XX XX XX | 2 + 2 + S |
| 1 . . . n | | | | |

Visual media sheet (VMS) data ends

| | | | | |
|---|---|---|---|---|
| Size of VMS | | | SS SS SS SS | 4 |
| Identifier | ASCII | TIE0 | 54 49 45 30 | 4 |

The start address of the visual media sheet (VMS) data is identified as TIS0 (Tag Information Start 0(NULL)) and the end address of the visual media sheet is identified as TIE0 (Tag Information End 0(NULL)) in the Table. 1. The markers TIS0 and TIE0 are used to identify the start and end of the visual media sheet data.

The marker ERS0 is used to identify the beginning of the reference structure as depicted in the Table. 1.

The information of each entry is grouped together and is stored in a form of structure. The structure of each entry starts with a marker CES0. The information can either be stored in a proprietary format or an electronic business card entity can be embedded within the proprietary content.

The information entry structure (IES) includes one or more fields, identified with the marker IESO. The one or more fields indicate the spatial relation between the embedded images and the information representing multiple entries in an image or a frame. The one or more fields enable application to read and extract the information from the image and links the image with the other information stored in the user data.

In one example, a contact detail is stored in the IES. The contact information may include a name, a phone number, electronic mail identification, a website, a fax number, a postal address and a birth date.

In another example, a weblink is stored in the IES.

In yet another example, details of a meeting is stored in the IES. The details may include a meeting schedule, an alarm, a venue of the meeting, a contact number for a web based conference, a conference identification number and an agenda of the meeting.

In one embodiment, the visual media sheet is encoded and is embedded with the thumbnail. The encoded visual media sheet is then stored.

The contact information of each entry can be written in the format as:

### [Type] [Size] [Data]

In an exemplary embodiment, the [Type] is a two byte number mapped to the fields. The [Size] is two bytes indicating the size of the data written for a particular field. Data information is written in [Data]. For example, [First name] [2 kb] [Adam].

In one embodiment, if the user desires to create a contact file then, exemplary information to be provided is as depicted in the Table 2 below.

TABLE 2

| Index | Type | Field | |
|---|---|---|---|
| 1 | 1a | First name | Name |
| 2 | 1b | Middle name | |
| 3 | 1c | Last name | |
| 4 | 2a | Phone number 1 | Number |
| 5 | 2b | Phone number 2 | |
| 6 | 3 | Birthday | Birthday |
| 7 | 4 | Email address | Email address |
| 8 | 5 | URL | URL |
| 9 | 6a | Address line1 | Address |
| 10 | 6b | Address line2 | |
| 11 | 6c | City | |
| 12 | 6d | Pin code | |
| 13 | 6e | State | |
| 14 | 6f | Country | |
| 15 | 7 | Group | Group |

In one embodiment, if the user is desired to share one or more contact information, then the exemplary contact information of each entry can be written in the format as:

### [Type] [Size] [Data].

[Type: First Name] [40 bytes] [Adam]
[Type: Phone Number1] [10 bytes] [987654321]

In another embodiment, if the user is desired to share one or more bookmarks, then the exemplary contact information of each entry can be written in the format as:

### [Type] [Size] [Data]

[Type: URL] [80 bytes] [www.ipl.com]
[Type: Tag] [10 bytes] [Cricket]

At step 415b, the thumbnail is associated with the information. The information associated with the thumbnail is then embedded.

At step 420, the generated thumbnails are arranged based on spatial details. The spatial details include generating co-ordinate values for positioning the thumbnail. The spatial details also include generating height and width values of the thumbnails. The thumbnails are then resized based on the co-ordinate values and the values of height and width. An index value is then assigned for the thumbnail. In some embodiments, the spatial details can be provided by the user. In one embodiment, pre-defined spatial details are provided. The pre-defined spatial details are received and applied on the thumbnails to be resized.

At step 425, the arranged thumbnail is saved with the associated information in a file. In an exemplary embodiment, the thumbnails and the associated information are saved in a multimedia file. In some embodiments, the associated information is encrypted, compressed and saved in the multimedia file. In one embodiment, the arranged thumbnails are rendered on a user interface. The rendering of the arranged thumbnails includes providing a plurality of thumbnails in a pre-defined pattern and displaying the embedded information corresponding to the plurality of the thumbnails in a file.

In another embodiment, the file is shared with a plurality of devices. The users of the plurality of devices can access the embedded information to perform one or more actions. The one or more actions includes but are not limited to, place a call, to send a text message, to send a multimedia message, to connect to a uniform resource locator, to view meeting details and to view electronic mails.

The method stops at step 430.

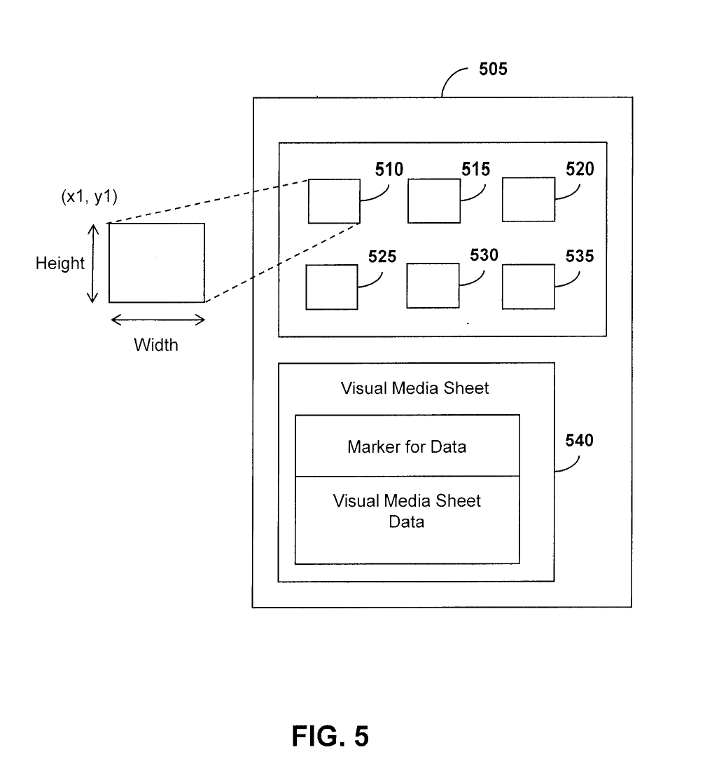

FIG. 5 illustrates creation of a file, in accordance with one embodiment. A plurality of thumbnails 510, 515, 520, 525, 530 and 535 is generated, the thumbnails corresponding to the respective multimedia files. Information is embedded within each of the plurality of thumbnails. The thumbnails are arranged based on the spatial details. The spatial details include the co-ordinate values (x, y). For example the co-ordinate values for the thumbnail 510 can be (x1, y1), as depicted in FIG. 5.

The spatial details also include height and width of the plurality of thumbnails. Each of the plurality of thumbnails is then resized based on the spatial details and is placed in the file. The embedded information is stored in the visual media sheet 540. The visual media sheet 540 includes information, for example, a marker for data and the visual media sheet data.

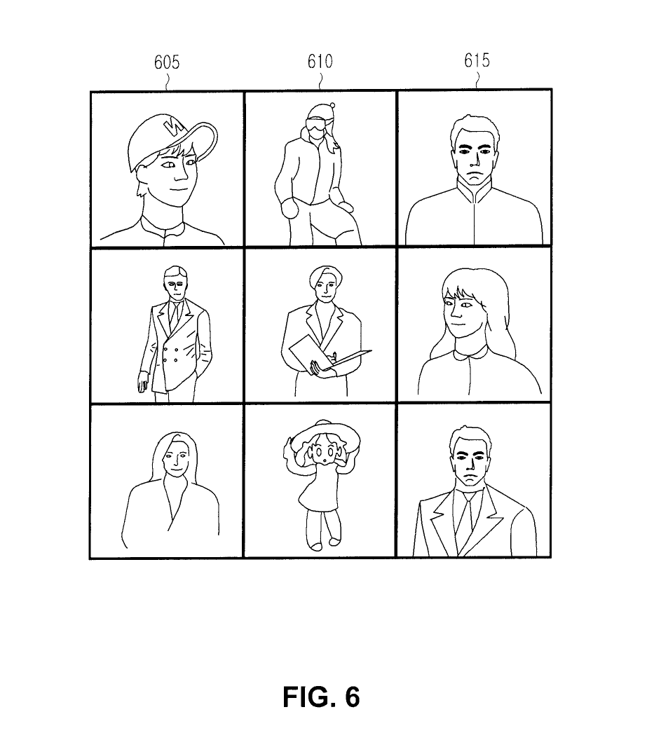

FIG. 6 illustrates an exemplary file with embedded information, in accordance with one embodiment. The generated thumbnails, for example 605, 610 and 615, are displayed on the user interface of the electronic device. The user can select a desired thumbnail to perform an action.

In one embodiment, the embedded information corresponding to the desired thumbnail is displayed on the user interface and one or more actions can be performed by the user.

In some embodiments, the thumbnail information is also displayed based on the cursor placement. The thumbnail information corresponding to the thumbnail is displayed to the user.

FIG. 6 also illustrates an exemplary file format for sharing meeting requests. If a user is scheduled a meeting with other plurality of users, then at least one of a caller id image, and a representative image of the plurality of users is received. The caller id images are then converted to the thumbnails and the corresponding information of the thumbnails is embedded with the thumbnails. The file is then shared with the plurality of users. The plurality of users can view the users attending the meeting.

In the preceding specification, the present disclosure and its advantages have been described with reference to specific embodiments. However, it will be apparent to a person of ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of present disclosure.

What is claimed is:

1. A method, operable in a processor within an electronic device, for embedding information in a file, the method comprising:
generating a thumbnail of a multimedia file;
embedding information associated with the thumbnail by identifying one or more markers to fill in the information on a visual media sheet and associating the thumbnail with the information;
arranging the generated thumbnails based on spatial details; and
saving the arranged thumbnails with the associated information in the file.

2. The method of claim 1, further comprising rendering the arranged thumbnails on a user interface.

3. The method of claim 2, wherein the rendering comprises:
providing a plurality of the arranged thumbnails in a pre-defined pattern;
displaying the embedded information corresponding to the plurality of arranged thumbnails; and
accessing the embedded information to perform one or more actions.

4. The method of claim 1, further comprising sharing the file with a plurality of devices in any of directly by wireline or wireless link and indirectly by wireline or wireless Internetwork and Intranetwork link.

5. The method of claim 1, wherein the identifying comprises:
identifying a start address of the visual media sheet data and an end address of the visual media sheet data based on at least one of the markers;
entering a reference structure in the visual media sheet;
providing the information based on the marker; and
storing the visual media sheet.

6. The method of claim 5, wherein the information is at least one of a contact details, a web link, a text, a multimedia data and a meeting detail.

7. The method of claim 1, wherein the arranging based on spatial details comprises:
generating co-ordinate values for positioning the thumbnail;
generating values of height and width of the thumbnail;
resizing the thumbnail based on the co-ordinate values and the values of height and width; and
assigning an index value for the thumbnail.

8. An electronic device for sharing embedded information in a file, the electronic device comprising:
a thumbnail generation unit for generating one or more thumbnails;
a visual media sheet generator for generating a visual media sheet with embedded information associated with the one or more thumbnails in visual media sheet locations based on one or more markers;
a storage unit for storing the generated visual media sheet;
a thumbnail organization unit for arranging the thumbnails in a pre-defined pattern based on spatial details; and
a display for displaying the file.

9. The electronic device of claim 8, wherein the display provides the one or more thumbnails in a pre-defined pattern, displays information corresponding to the one or more thumbnails and allows access to the embedded information to perform one or more actions.

10. The electronic device of claim 8, further comprising a visual media sheet analyzer for extracting and rendering information from the visual media sheet, corresponding to the thumbnails.

11. The electronic device of claim 8, further comprising a communication interface for enabling the electronic device to communicate the multimedia file.

12. The electronic device of claim 11, wherein the communication interface is configured to couple the electronic device to one of an intranetwork and an Internetwork by one of a wireless and wireline link.

13. The electronic device of claim 11, wherein the communication interface is configured to couple the electronic device to one of: a storage device directly connected to the electronic device, a storage device in a wireline or wireless network connected to the electronic device and a storage device indirectly connected to the electronic device over the Internet by wireless or wireline link.

14. The electronic device of claim 8, wherein the information is at least one of a contact details, a web link, a text, a multimedia data and a meeting detail.

15. A processor-readable medium including a set of processor readable instructions that when executed by a processor in an electronic device cause a method for sharing embedded information in a file, the method comprising:
generating a thumbnail of a multimedia file;
embedding information associated with the thumbnail by identifying one or more markers to fill in the information on a visual media sheet and associating the thumbnail with the information;
arranging the generated thumbnails based on spatial details; and
saving the arranged thumbnails with the associated information in the file to be shared.
